(19) United States
(12) Patent Application Publication
(10) Pub. No.: US 2024/0158059 A1
(43) Pub. Date: May 16, 2024

(54) VEHICLE FOR UNDERWATER SURVEY

(71) Applicant: Vertigo3.org Pty Ltd, Manly, Queensland (AU)

(72) Inventor: Brett Kettle, Manly (AU)

(21) Appl. No.: 18/550,593

(22) PCT Filed: Mar. 24, 2022
(86) PCT No.: PCT/AU2022/050270

§ 371 Date: Sep. 14, 2023

(30) Foreign Application Priority Data
Mar. 24, 2021 (AU) 2021900879

(51) Int. Cl. B63G 8/42; B63G 8/00; B63G 8/18; B64U 10/60

(52) U.S. Cl. CPC B63G 8/42; B63G 8/18; B63G 2008/007; B64U 10/60

(57) ABSTRACT

An aspect of the disclosure relates to a non-destructive device and method of determining the pressure of liquid within a pipe. The method comprises the steps of transmitting, by a first probe, ultrasound, wherein the first probe is disposed on a surface of the pipe. The method then receives, by a second probe, the transmitted ultrasound, the second probe being disposed on a surface of the pipe opposite to the first probe. The celerity of the transmitted ultrasound through the liquid within the pipe can then be determined. The pressure of the liquid can then be determined based on the determined celerity of the transmitted ultrasound.

### FIELD OF THE INVENTION

The present invention relates to the field of underwater survey. More particularly, the invention relates to autonomous and semi-autonomous underwater vehicles, or underwater drones, useful for conducting underwater surveys, specifically surveys of high-relief underwater environments to assess biophysical or biochemical conditions, and more particularly to those that require the capture of vision for habitat classification or target identification.

### BACKGROUND TO THE INVENTION

The health of the worlds coral reefs and surrounding marine ecosystems are the subject of escalating concern. Marine ecosystems are being adversely impacted by numerous factors, including climate change, agricultural run-off, pollution, resource extraction and excessive recreational use. Although there is a general understanding of the dangers, there are very little hard data from which to make a rigorous assessment of the magnitude of the problem across broad spatial scales. This is due, at least in part, to difficulties in collecting data in marine environments.

There are numerous techniques for collecting ecosystem data at broad spatial scales underwater, but most wide area survey equipment is designed for producing hydrographic survey maps. The approaches include surface-based echo sounding (sonar), towed drones that provide a platform for various sensors and autonomous underwater vehicles with similar sensor arrays. By way of example, International Patent Publication WO2020/257879, assigned to Ron Allum Deepsea Services Pty Ltd, describes an underwater glider with enhanced stability and versatility. However, this device and devices like it are not suitable for surveying large areas of underwater reefs and surrounding ecosystems. They are simply too large and insufficiently manoeuvrable to get close enough to areas of interest to make meaningful measurements, and too slow to cover useful areas in a day. An ideal device would move autonomously and quickly in all six primary ‘degrees of freedom’ (6dof): in a translation sense—forwards and backwards (X axis, termed ‘surge’ in marine applications), left and right (Y axis, ‘sway’), and up and down (Z axis, ‘heave’); in a rotational sense, orienting itself or maintaining orientation in the face of strong displacing forces in those same axes (X=roll, Y=pitch, Z=yaw); and with agility, being able to effect these changes with little delay because the displacement methods have little inertia to overcome, or are sufficiently authoritative in the forces they can bring to bear that they can quickly overcome system inertia. In certain circumstances the need to move quickly over large distances might favour the device being towed, therefore dispensing with surge and having 5dof for the ideal device. It should also be noted that the rotation of hydrodynamic wing surfaces at speed, whilst strictly not a translational movement, is capable of causing rapid translational movements of the entire device if control surfaces are authoritative enough. In this case 3dof roll, pitch and yaw produce ideal 6dof movement, or in the case of towing, 5dof movement.

The problem of moving around a reef quickly is particularly difficult when seeking to record relatively small but extremely significant features such as the crown-of-thorns starfish that live amongst rugged coral outcrops. It is essential to get close to reef structures to be able to count the number of crown-of-thorn starfish infesting a reef, or to identify coral species. This also means being able to look in, around and under all parts of the reef. This task is possible at very slow speeds and over small areas using autonomous and remotely operated underwater vehicles (AUV and ROV, respectively) that have high static stability in one of more dof, but otherwise move authoritatively with high degrees of freedom (dof). AUVs and ROVs typically, translate easily in X (sway), Y (surge) and Z (heave) dimensions; and rotate easily about the Z-axis (yaw). In order to conserve power these underwater vehicles aim for neutral buoyancy and inherent (static) stability, which dampens rotation about the X-axis (pitch) and Y-axis (roll). These devices are bulky and generate much drag and little hydrodynamic lift. They therefore consume significant power at even slow speeds, and as a result are unsuitable for broad area surveys of the type mentioned above. Power limitations can be overcome by a surface tether with adequate conductors, but this introduces a range constraint based on drag of water currents on the tether and power attenuation inherent in thin cables.

The current technique used for biophysical data collection over broad areas in reefal environments is the “Manta Tow”, sometimes also referred to as ‘towboarding’. This method has been in use since the 1950s, because no other method has proven suitable for close-proximity visual observation amongst corals over large distances. Manta Towing requires a snorkel diver (observer) to be towed at a consistent speed behind a boat, holding onto a flattened board that, properly manipulated, takes the observer between the surface and approximately 8 m depth, and can be guided left and right of track by several metres if the observer is skillful and strong. In a dof analysis using maritime language, Manta Tow would describe the 1.5dof (heave) with high dynamic stability in the remaining dimensions. In the Mana Tow method, the observer makes a visual assessment of specific variables during successive two-minute periods. At the end of every two minute ‘tow’, the boat stops and the observer manually records their observations on waterproof paper attached to the manta board, or calling it back to observers in the boat. The technique relies on trained experts and is limited by tow-speed, depth, favourable weather conditions, and the amount of visual information that a human is capable of processing in real-time. Some places cannot be surveyed with these methods because of dangers from sharks or crocodiles.

Towing human observers behind a boat allows the boat to provide propulsion but is limited to slow speeds and poor flight path control, and includes safety risks including those associated with breath-holding. Some success has been achieved by mounting sensors on a negatively buoyant device towed behind a boat (a Towed Underwater Vehicle or TUV), such as the recently published “A Portable Shallow-Water Optic Fiber Towed Camera System for Coastal Benthic Assessment” doi: 10.1109/OCEANS.2018.8604689ⁱ. This method has no autonomous flight path control, relying on lateral movement of the boat, imprecise manual methods of raising or lowering the TUV (vessel speed, winches or hand-retrieval) or the addition of static mass to the underside to carry the unit deeper at a given speed, to position the sensor relative to the seabed. This results in a heavily constrained flight path, with no effective control over cross-track positioning, and poor vertical responsiveness. Such systems generally require significant mass elements placed well below the tow attachment point, to provide static righting forces that maintain a vertical orientation in the face of turbulence or cross-currents. In an autonomy sense, such devices would be described as 0dof with high static stability on roll and pitch axes. The resulting control characteristics are suitable for slow tow speeds in low-relief terrain, but cannot work effectively at higher speeds, or in high-relief terrain. It also limits surveys to places where boats can safely operate and to the use of a single such device towed directly behind a boat. Importantly for operations in rugged coral reef terrain, the negative buoyancy that results from an excess of ballast over flotation leads to rapid entanglement as TUV headway is lost by variations in the towing vessel's speed or path (such as a sharp turn). These entanglements damage the coral reefs and the underwater vehicle, and put at risk the lives of those aboard the towing vessel.

Further improvements to the stability of TUVs include the addition of fixed control surfaces that are mounted near to or aft of the tow point and provide static stabilization in one plane. This is usually achieved by inclusion of a vertical surface to minimise yawing to either side of the boat's track, such as that found on the Spot-X Pro-Squidⁱⁱ. Alternative configurations include the static surface being angled to provide a displacement force, such as ‘depressor’ surfaces added to increase down-force where mass alone is insufficient to overcome the upwards-directed component that cable drag forces exert on a towed body, and that ultimately limit its ability to reach greater depths. The depressor wings fitted to Shark Marine Systems towed sonar unitsⁱⁱⁱ or Divex Marine side-scan sonar^{iv} are examples of this.

Further improvements to stability include static stabilization in both yaw (horizontal motion) and pitch (vertical motion), such as that of the JW Fishers “TOV-2”^{v}. Note that vertical and horizontal stabilizing surfaces are not limited to the vertical and horizontal planes, but may include surfaces at other angles. This is the case for yaw stabilisation of the TOV-2 mentioned above, which has its vertical stabiliser represented by a pair of canted surfaces that contribute primarily to yaw stability, and secondarily to pitch stability. Note that these stabilizing surfaces do not need to be planar, but could be curved, providing that they are capable of generating a useful component of force in the required direction.

The abovementioned improvements provide only for increasing static stability, or the depths or speeds at which a TUV may maintain static stability. Imparting high manoeuvrability to TUVs can be achieved by adopting making the stabilizing surfaces actuated so that they generate a variable displacement force that can be used to alter the attitude (roll, pitch, yaw) of the TUV in a manner that changes the TUV flight path. Flight path changes are affected when an actuator alters the effective angle of attack (AoA) to water flowing over the control surface, such as the wing and tailplane structures of the Bellamare ‘In Situ Ichtyoplankton Imaging System’ (ISIIS), or ISE Aurora Active Towfishvi. The ISIIS towfish can autonomously operate in 1dof, profiling up and down through the water column as it is towed, but relies on static stability in the remaining dimensions.

The recently-released ixblue FlipiX is a 3dof TUV, with autonomous control of pitch, roll and heave; relying on high static stability for yaw, sway and surge.

Further successes have been made with autonomous underwater vehicles (AUVs). These require power for operating sensors, communications and for propulsion. Energy storage, propulsion methods and the need for high degree of static stability result in both relatively high mass and correspondingly large volume, which in turn increases drag and momentum and limits agile manoeuvrability. Passive propulsion AUVs (‘ocean gliders’) have a flight path heavily constrained by their reliance on buoyancy and cannot sustain a sensor flight path in close proximity to the seabed. Motor (thruster)-equipped AUVs provide a useful flight path for close-proximity sensors when operated in low energy environments (low currents, low turbulence). Powered AUVs can operate at fast speeds, or slowly in medium currents, for only short periods of time, with operations limited by on-board energy storage capacity. Further increases in propulsion or energy storage exacerbate drag and momentum issues and therefore compound the challenges of precise flight path control at speed. AUVs therefore struggle to balance power consumption with the need to advance in the presence of strong currents or maintain stability in the presence of strong turbulence, and must therefore be kept at greater distance from the seabed to avoid collisions. AUVs also suffer from poor underwater position-finding and communications bandwidths that limit their navigational ability and the opportunity for human-in-the-loop decision making.

TUVs and AUVs can use surface tethers that provide useful position-finding, power supply, or communications bandwidth. Some include control systems operated remotely from the surface (Remotely Operated Vehicles or ROVs). The tether cable provides useful improvements in position-finding and human control. It also reduces or obviates power supply limitations and therefore enhances flight path control in turbulent settings. On the other hand, strong currents or fast speeds impose practical limitations on cable drag, preventing high speed operation or operations in strong currents.

Tether cables impose drag forces in approximate proportion to their diameter and the across-current component of their length. For AUVs these forces are counteracted by additional thrust, requiring higher power consumption and mass, offset by larger buoyancy chambers; for TUVs, by increasing downward-directed force through the addition of mass, hydrodynamic ‘lift’, or a combination of both of these. TUVs that utilise mass to attain greater depth at a given speed, or greater speed at a given depth, are necessarily negatively buoyant, and sink quickly if the towing vessel slows, or a tight-radius turn is performed. This may not be problematic over sandy seabeds, but damages both seabed and device in rugged hard terrain, and risks entanglement and loss of the device, especially in areas like coral reefs.

Power supply over tether cables is limited primarily by tether length and the cross-sectional area of the conductor. Providing adequate power supply at depth typically requires higher diameter conductors, higher supply voltages and currents, and greater physical protection of cables.

For TUVs operating on conventional tethers, drag forces generated by the tether are generally at least one order of magnitude greater than drag forces generated by the TUV, and require high load-bearing cables to sustain operations at greater depths and higher speeds. Methods used to reduce these drag forces include the use of slimmer tethers, or faired tethers.

Sensor orientation in TUV/AUVs is further constrained by orientation of the TUV/AUV body, which usually relies on separating the centre of mass and the centre of buoyancy to assist with stability. Some success has been made with gimbal mounted sensors, but these are constrained by line-of-sight shielding from the AUV body, or the need to synchronise multiple sensors by co-location or on multiple gimbals. The advantages of gimbals, and the sensors they support, are further reduced by relatively large separation distances between the AUV and its targets.

Compounding TUV handling, tether management and flight path control issues is the requirement to operate from small boats in shallow and topographically complex underwater environments where groundings and waves must be avoided. In such situations devices must be small enough for stowing, lightweight enough for manual deployment, and rugged enough to withstand the rigours of the setting. Additionally, many TUV/AUVs cannot be tasked into shallow areas, especially those where waves are breaking, because they cannot maintain control over manoeuvring in strong turbulence or currents.

Constraints of poor underwater visibility, or rapid attenuation of electromagnetic signals, limits the effective swathe width for seabed observation. Broad-area underwater surveys therefore typically require many closely-spaced parallel passes to ensure the capture of contiguous data for an area of seabed. Current methods used to reduce the number of parallel passes focus on streaming multiple devices from a series of towing points, spaced across a vessel's transom; or wider spacing achieved by vessel-mounted transverse booms that allow tow points well outside of the vessel's beam. Effective boom length is limited by vessel roll characteristics and mechanical limitations of the vessel's superstructure. These problems are compounded in small vessels that tend to roll more in a given sea state. As a result, it is rare to employ more than a single TUV behind a vessel.

The practical effect of these limitations is an inability to move sensors quickly through complex topography in high currents, at distance from a surface vessel and over long durations, with large effective swathe widths, while maintaining finely controlled positioning in close target proximity, and allowing high freedom for the orientation of sensors.

### SUMMARY OF THE INVENTION

In one form, although it need not be the only or indeed the broadest form, the invention resides in a semi-autonomous towed underwater vehicle comprising:
a body comprising one or more watertight chambers and external structural members;
forward wings attached to left and right sides of the body, with at least one wing oriented substantially horizontally, wherein the left side and right side wings contain moveable portions each connected to the same actuator and actuated in a manner that causes changes in airfoil shape to effect positive or negative pitching moments during underwater flight;
one or more rearward wings attached to the body, with at least one independently operated actuator connected to an actuated portion oriented substantially at a horizontal angle, and at least one independently operated actuator connected to an actuated portion oriented substantially at a vertical angle;
one or more sensors mounted on the body that collect biophysical or chemical data from the environment around the vehicle;
one or more sensors mounted on the body that collect data about the movement of the vehicle through its environment;
an independent powered source mounted in the underwater vehicle's body and capable of meeting the power supply needs of actuators, sensors, devices and processors of the underwater vehicle;
a processor mounted in the underwater vehicle's body that receives data from sensors and encodes it for transmission, receives signals from a second processor mounted on the towing vessel, and generates control signals to independently actuate each moveable part of a wing to navigate the vehicle;
a second independently powered processor mounted on the towing vessel, that collects data related to surface conditions, processes data from the underwater vehicle, communicates data and instructions to the underwater vehicle, and communicates data to an operator;
a single tether cable that pulls the underwater vehicle through the water, and provides a means of communicating data between the underwater vehicle and the surface processor; and
a means of firmly connecting the tether to the underwater vehicle, and at its opposite end to the towing vessel, in a manner that does not impede data transmission.

Each part of the forward wing preferably has an aerofoil shape that can provide negative lift when oriented at the correct angle of attack. Each part of the rearward wing may have the same shape.

The plurality of sensors may include one or more visible spectrum cameras, one or more wavelength-specific cameras, one or more depth measurement devices, and/or one of more acoustic sensors. The choice of sensors mounted on the vehicle is determined by the particular task requirements.

Sensors include pressure sensors and other sensors to measure the movement of the vehicle, including sensors to measure pitch, yaw and roll, surge, sway and heave.

In a further embodiment of the invention the left and right halves of the forward wings of the underwater vehicle are connected to separate actuators.

In a further embodiment of the invention the forward wings of the underwater vehicle may include portions oriented at a substantially vertical angle, and these may include moveable portions connected to actuators.

In a further embodiment of the invention the actuated portions of one of more wings may include the entirety of that wing.

In a further embodiment of the invention there includes additional sensors on the towing vessel and/or the underwater vehicle, to determine to location of the underwater vehicle with respect to the towing vessel's location.

In a further embodiment of the invention the body of the underwater vehicle is substantially flattened in the vertical plane.

In a further embodiment of the invention multiple underwater vehicles are towed from a common towing vessel.

In a further embodiment of the invention the towing vessel is an aerial drone.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 is a sketch of a first embodiment of an underwater survey vehicle, which is semi-autonomous;

FIG. 2 is an end view of the embodiment of FIG. 1;

FIG. 3 is a side view of the embodiment of FIG. 1;

FIG. 4 is a sketch of a wing profile with negative lift;

FIG. 5 shows the connection of a push rod to a wing;

FIG. 6 shows the connection of a push rod to an actuator;

FIG. 7 shows the connection of a wing to the body;

FIG. 8 shows the arrangement of wing connections;

FIG. 9 shows a sensor pod and probe;

FIG. 10 shows a tether connection;

FIG. 11 depicts diving and climbing of the vehicle of FIG. 1;

FIG. 12 depicts navigational manoeuvres of the vehicle of FIG. 1;

FIG. 13 is a sketch of a second embodiment of an underwater survey vehicle having a propulsion unit; and

FIG. 14 is a sketch of the underwater vehicle of FIG. 13 in a glide mode.

### DETAILED DESCRIPTION OF THE INVENTION

Embodiments of the present invention reside primarily in an underwater vehicle for conducting biophysical surveys close to the seabed and in the vicinity of obstacles. Accordingly, the integers and method of use steps have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

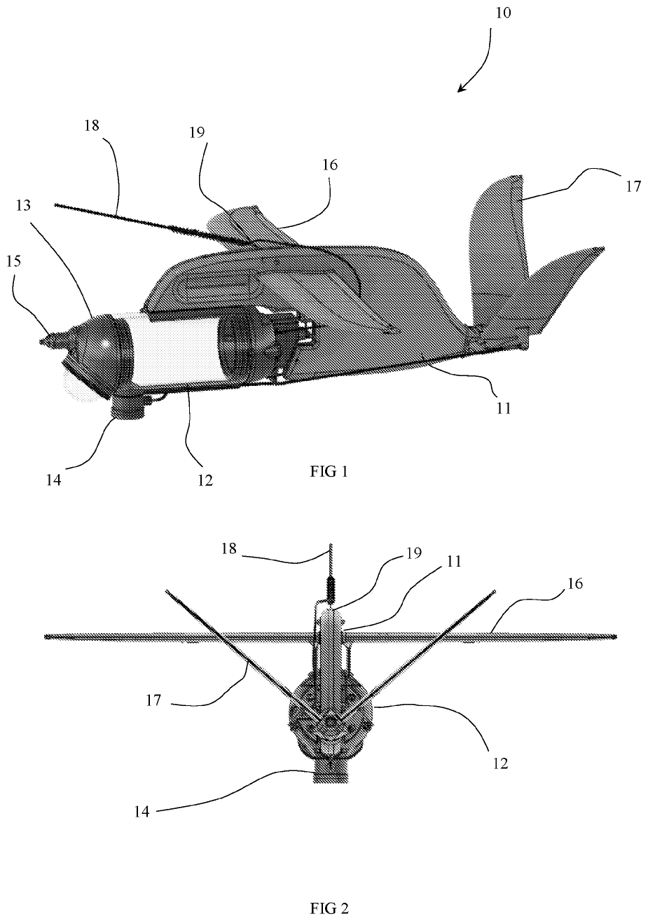

Referring to FIG. 1 there is a shown a first embodiment of an underwater biophysical survey vehicle 10. The vehicle comprises a body 11 with a waterproof chamber 12 for holding various electronic components. The body 11 is substantially planar. As seen most clearly in FIG. 2, the body 11 is relatively thin and elongate.

Forward of the chamber 12 is a sensor pod 13 containing various sensors, which are described in greater detail below. Below the sensor pod 13 is a sonar transducer 14 and projecting from the sensor pod 13 is a probe 15 with various measurement devices for monitoring the movement of the vehicle through the water.

The vehicle 10 comprises a first forward set of wings 16 that are independently movable with respect to the body 11 and a second rearward set of wings 17 that are also independently movable. The forward wings 16 and rearward wings 17 are operated to effect translation, pitch, yaw and roll of the vehicle 10. As described below, the forward wings 16 and rearward wings 17 provide control to cause the vehicle to descend, ascend, tilt up, tilt down, roll left, roll right, translate left, translate right and invert.

The embodiment of FIG. 1 is a towed version of the vehicle that is towed behind a surface craft by tether 18. The tether 18 comprises strength members and a communications cable. The communications cable may be a reinforced fibre optic cable to provide fast, high bandwidth communications.

The tether 18 provides a number of advantages over fully autonomous vehicles. The tether will be of a known length and measurable orientation, thus facilitating accurate determination of the location of the vehicle and ability to calculate accurate navigational corrections. The fibre optic link allows for data to be quickly communicated to the underwater vehicle from the towing craft, which is important for obstacle avoidance. Fully autonomous AUVs are notorious for getting ‘lost’ because they rely on ‘dead reckoning’ which, at slow speed and in currents of similar magnitude to speed, works exceptionally poorly.

The tether also facilitates a human-in-the-loop feedback process, that allows adaptive management of search paths, or asset redeployment decisions whilst the vehicle is still underwater performing tasks. The ability to have fine control of the navigation of the vehicle means multiple vehicles can be towed from the one surface vessel without a risk of collision.

There is benefit to the towing cable being exceptionally thin but allowing high bandwidth communication. A thin tether reduces drag, which otherwise means that the vehicle must become bigger and heavier (and therefore less maneuverable) to exert enough down-force to overcome the vertical component of cable drag.

However, the inventor realizes that there will be situations when the vehicle can be operated in a fully autonomous mode, as mentioned later. This possibility arises from improvements to dead reckoning navigation that arise with greater speed. If currents and IMU errors are small compared to forward velocity then accurate navigation between ‘fixes’ is possible. The minimal drag of the vehicle described herein makes viable fast travel for reasonable periods of time and to make period excursions to the surface to send and receive data (incl GPS).

Looking to FIG. 2, it can be seen that the forwards wings 16 are substantially horizontal in neutral operation. That is to say, the forward wings 16 are coaxial and perpendicular to a long axis of the body 10. The rearward wings 17 are angled in a V-shape, and extend the moment arm of the rear wings to provide pitch and rudder controls, which enhances stability.

For the towed embodiment of FIG. 1, it is also significant that the forward wings 16 are high-mounted on the body 11, in close proximiy to the tether point 19 where the moment arm of the towing forces minimises adverse roll forces that need to be counteracted by the forward wings 16 during lateral manouevres. Also, the rearward wings 17 are attached to the body 11 at greater distance from the tether point 19, so that the longer moment arm of the rudder function counteracts the lateral forces of the tether 18. The rearward wings 17 are also attached to the body at a position with greater vertical separation from the tether attachment, so that operation of the rudder function best counteracts adverse rotational forces during lateral manouvres. The forward wings 16 and rearward wings 17 could be reversed in their position, although such a configuration is less stable and requires greater computerised control.

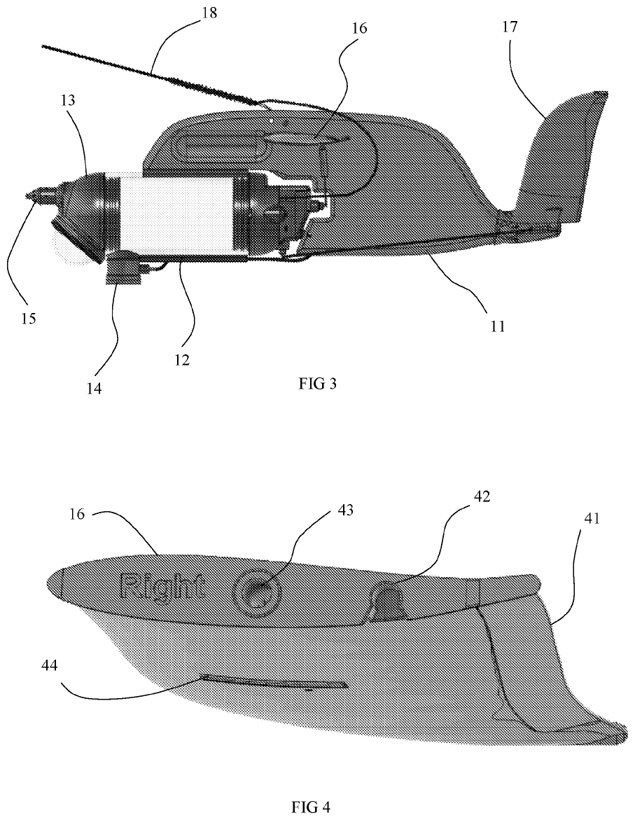

Looking at FIG. 3, it is clear that the tether 18 is connected to the body 10 just forward of the forward wings 16. It has been found that enhanced hydrodynamic performance is achieved if the tether point 19 is just forward of the forward wings 16. This is at least in part dependent on the locations of the centres of gravity, lift and drag of the vehicle 10 and the relative proportion of control surfaces forward or rearward of the tether attachment point.

In the embodiment of FIG. 1, the forward wings 16 are designed to provide negative lift. That is to say, they have a wing profile (cross-sectional shape) designed to provide a down force as the vehicle moves through the water, even at neutral angles of attack. The vehicle is designed to have positive buoyancy so that it returns to the surface if the tether breaks or forward propulsion ceases. By employing an aerofoil with negative lift, the vehicle will benefit from increase dive capability as it moves forward. The depth may then be adjusted by adjustment of the angle of the wings, as described below. This is particularly important for a towed underwater vehicle (self-propelled) as it causes the vehicle to dive when the wings are in a neutral position. An example of a suitable wing is shown in FIG. 4. The trailing edge 41 of the wing 16 turns up to produce down force as the wing moves through the water. The specific size, shape and angles to be employed depends on the size, weight and buoyancy of the vehicle and the intended range, depth and operating speed.

The aerofoil shape described above may not be necessary for a powered underwater vehicle, although it will be useful to improve glide path in a glider mode. That is to say, to extend the operational range of an autonomous underwater vehicle it may be useful to operate in a non-powered mode for part of the time. At such times the range may be extended by the aerofoil wing shape. The aerofoil wing shape is also less important for towed shallow water operations (to 20 m) than for deeper operations. When down force is not necessary, it may be advantageous to select a symmetrical (non-lifting) wing profile, preferably as thin as structurally possible.

It is also possible to select an airfoil shape that represents a compromise between efficiency in a dense medium such as water, and a lighter medium such as air, and which, when flying through air as a thinner medium, achieves effective lift, and upon transition to water entry can the perform as described above.

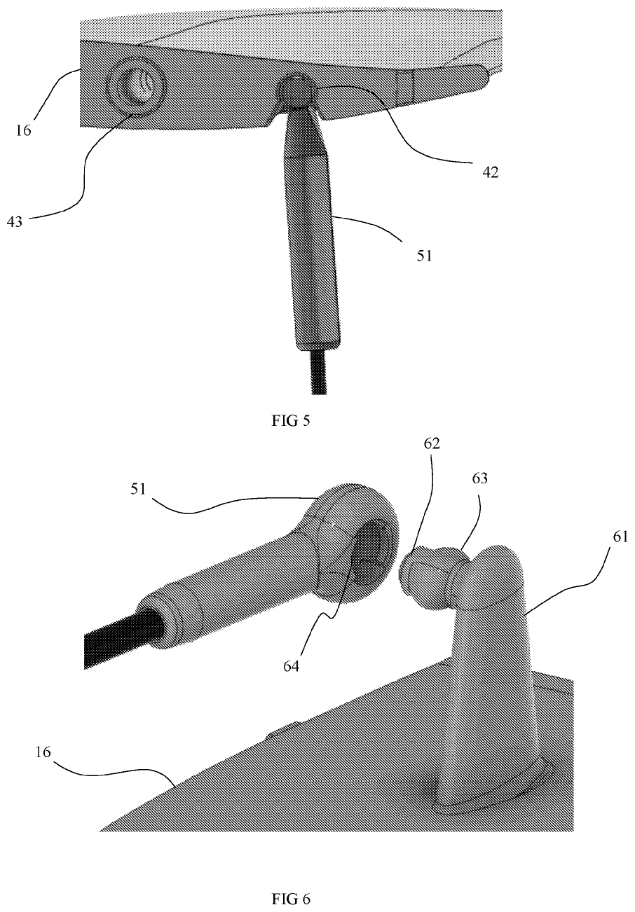

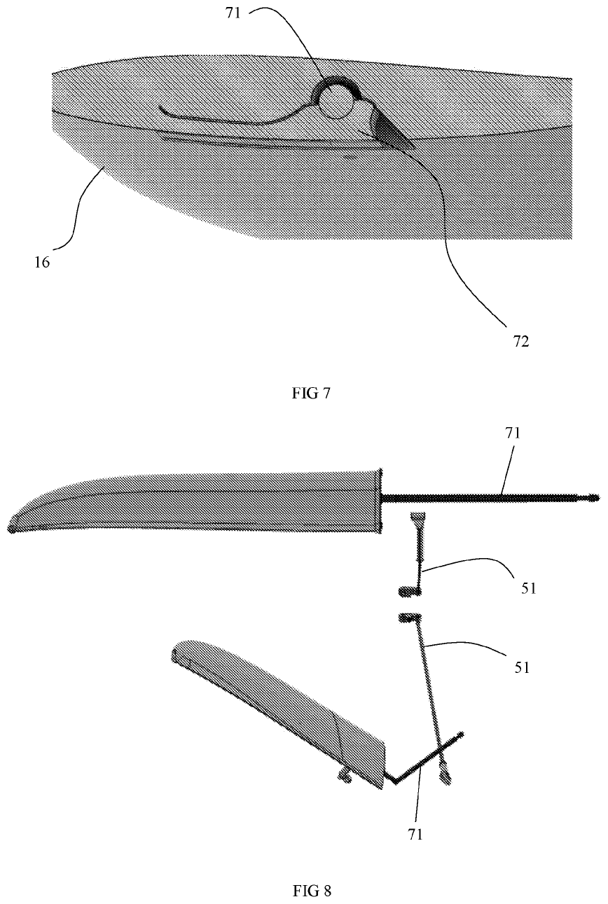

Also evident in FIG. 4 is a control connection 42 and wing connection 43. The forward wings 16 are each independently adjustable using pushrods, as shown in FIG. 5, to rotate each wing about the wing connection 43. The pushrods 51 slide into the control connection 42 and the wings are held in place by connection assembly 71 which mates with connection portion 44. The opposite end of each push rod is connected to an actuator 61 as shown in FIG. 6. The actuator 61 is driven to its correct position by a servo motor (not shown) located in the chamber 12 that rotates or extends as commanded by the processor and effects movement of the push rod mechanical connection. There are four servo motors each driving one of the forward wings (left and right) or one of the rearward wings (left and right). The use of four servo motors allows for independent control of the pitch of each wing, which enables control of the vehicle in pitch, yaw, and roll, and pitch-independent translation over depth.

The connection between the push rod 51 and the actuator 61 is a bayonet style ball joint. In one embodiment, the ball 62 is moulded in plastic as a complete unit. The ball 62 has protrusions 63 that engage with recesses 64 in the push rod 51 to provide a positive engagement when rotated. It is important that the push rods and wings be easily removable for packing and storage without multiple small parts that are easily dropped and lost on a pitching boat. It is also important that all parts of the vehicle are resistant to corrosion in a marine environment.

The forward wings 16 and rearward wings 17 connect to the body 11 by axis rod 71 and slip on snap lock or other quick release fittings 72 as shown in FIG. 7. The fitting 72 matches with the connection portion 44 shown in FIG. 4. The arrangement of axis rod 71, with snap lock fitting 72 in connection portion 44 allows quick and easy assembly and disassembly. The layout of axis rods 71 and push rods 51 for the wings on one side of the vehicle is shown in FIG. 8. The other side is the same.

The forward wings 16 and the rearward wings 17 are rotated about the connection points 71, 72 by the pushrods 51.

The connection points 71, 72 are located on the axis of rotation of the forward wings 16 and rearward wings 17 respectively. The location of the axis of rotation of each wing is selected to (a) balance the flight forces on either side of the axis so as to minimise the power required to actuate the wing's movements; and (b) to ensure just enough imbalance in (a) that there is always sufficient residual force to prevent turbulent flows from destructively shaking the control surface.

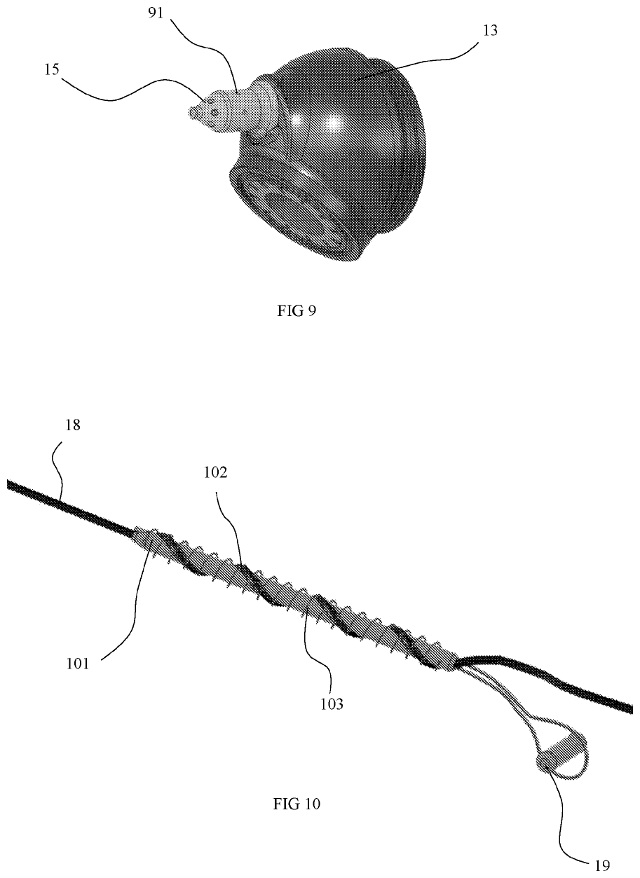

A sensor pod 13 is located towards the front of the vehicle, as shown in FIG. 1 and FIG. 9. The sensor pod 13 may contain multiple sensors for recording data about the environment surrounding the vehicle 10. For instance, an oblique (forward and downwards) looking camera provides a view that allows a computer or human observer to make navigational decisions by perceiving distance to obstacles while still observing a portion of the seabed on a vertical projection. The forward-looking camera may also have surrounding illumination for low-light operation. Other sensors, such as forward-looking green or blue-band lidar, sonar or doppler velocimeters may be useful for autonomous operation to identify and avoid obstacles. It is also appropriate to monitor environmental conditions, such as water temperature and turbidity. The sensor pod 13 is configured to be easily interchangeable in the event that a different sensor pack is required for a particular application.

In order to provide appropriate control signals to the vehicle 10, it is necessary to monitor the movement of the vehicle through the water. A probe 15 is located at the front of the vehicle as shown in FIG. 1 and in more detail in FIG. 9. The probe 15 has multiple ports 91 and contains custom electronics (not shown) that incorporates multiple pressure sensors and software to multiplex signals and determine depth, thru-water velocity, orientation and thru-water sideslip. The probe 15 may also include an accelerometer for determining orientation of the vehicle. The probe 15 is quickly swappable in the event that debris blocks the ports 91.

An on-board processor (not shown) in the chamber 12 generates control signals from the data received from the electronics in the probe 15. In addition, signals may be received from the surface to effect manoeuvres determined by a human operator or autonomously by a surface computer in the towing vessel. These signals are preferably transmitted along an optical fibre contained in the tether, but may be transmitted by any other suitable manner for rapid underwater communications. A suitable tether 18 is shown in FIG. 10. To provide a strong yet easily changeable connection the tether cable 18 includes a hard body portion 101 with a tapering spiral groove 102 through which the tether cable runs. The tether cable 16 is held in place by a removable conforming tensioner 103, such as a spring or elastomeric strip. Under load, the tether cable is held more tightly into the tapered spiral groove 102 of the hard body 101, thus providing a strong mechanical connection to the cable while protecting the fibre optic member of the tether cable from excessive pinching and bending.

A surface computer located in a towing vessel serves a number of purposes. Firstly, it makes flight control decisions based on information obtained from the vehicle 10 but also using other information that cannot be easily obtained underwater, such as GPS coordinates, heading, and accurate speed. Secondly, the reduced power supply constraints of the surface vessel mean that it is able to process vast amounts of environmental data in real time, allowing human-in-the-loop decision making. Human-in-the-loop decision making permits rational choices to be made in response to changing underwater observations.

The benefits of human-in-the-loop decision making are underwater amplified if the observer has a means to quickly inspect data being generated by the TUV, and is provided with a means to relay instructions to the glider in response to changed requirements.

It will be apparent that the vehicle 10 needs to be deployed with the sensor pod 13 looking down. It may happen that the vehicle 10 deploys upside down. In one embodiment the vehicle 10 is programmed with an auto-invert function to effect correct orientation. The measurements from the probe 15 and the on-board processor 12 can indicate the orientation of the vehicle. To the extent that the orientation is incorrect a pre-loaded routine in the processor in the chamber 12 operates the servo motors to adjust the forward wings 16 and rearward wings 17 to invert the vehicle to correct orientation for operation.

The ability to invert the vehicle can also be used for rapid ascension of the vehicle 10. As shown in FIG. 11, the aerofoil wing profile will generate down force and cause the vehicle 10 to dive when moving forward, even at zero angle of attack. Inverting the vehicle with a negatively camber wing will cause it to ascend more efficiently.

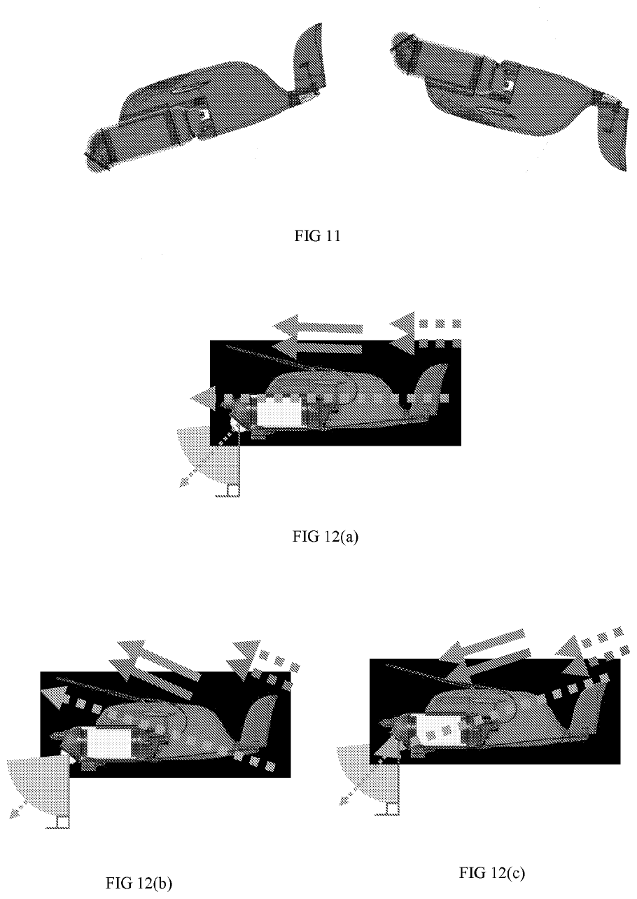

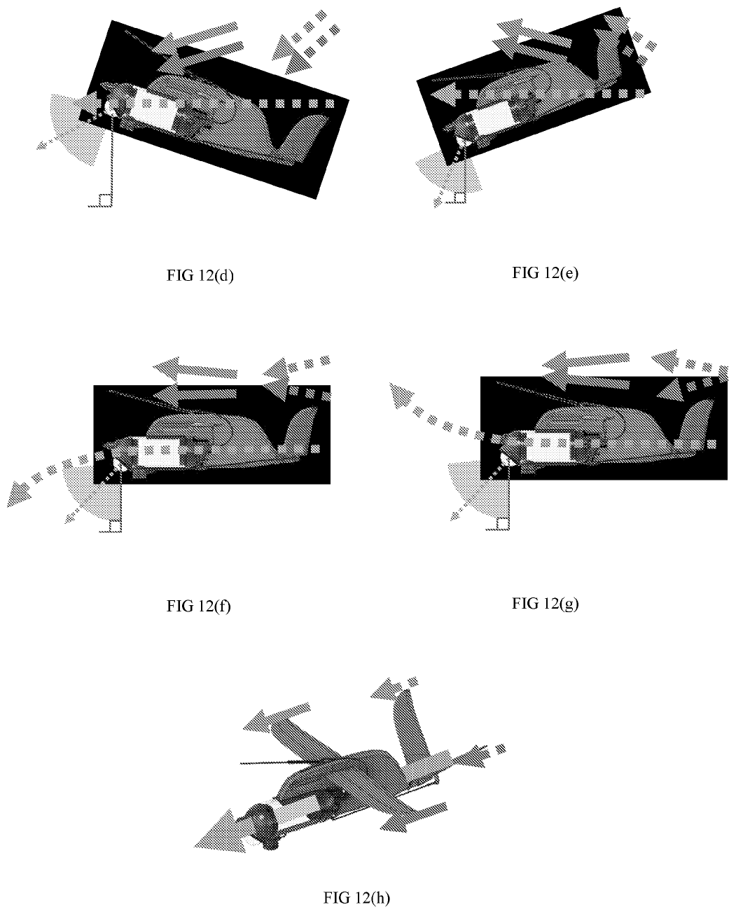

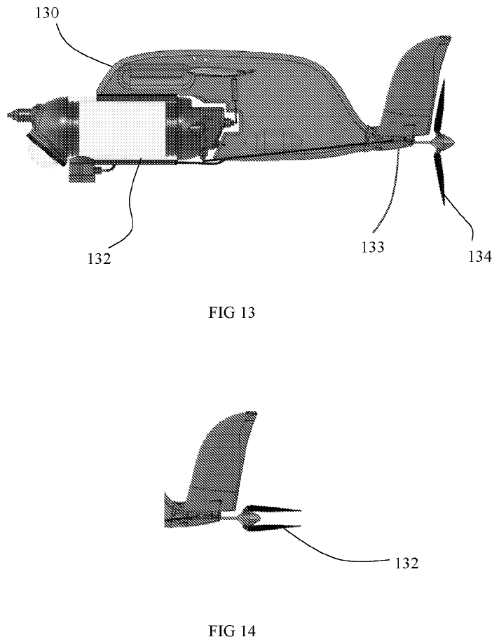

A range of possible maneuvers is shown in FIG. 12. FIG. 12(a) shows the vehicle in stable, level motion. By pitching the forward wings and countering the pitch with the rearward wings, the vehicle will ascend without pitching the sensor pod, as shown in FIG. 12(b). In similar fashion, pitching the forward wings the opposite way and compensating with the rearward wings will cause the vehicle to descend, as shown in FIG. 12(c). Pitching the forward wings for ascent but operating the rearward wings for descent will cause the vehicle to pitch the sensors to look further forward but maintain depth as shown in FIG. 12(d). Similarly, pitching the wings in the opposite direction will cause the vehicle to pitch the sensors to look closer but maintain depth as shown in FIG. 12(e). As depicted in FIG. 12(f) and FIG. 12 (g), the vehicle can be caused to roll left or right without changing the pitch of the sensor pod. This is useful for observing around structures, such as reef outcrops. In similar manner the rearward wings can be used as a rudder with pitch compensated by the forward wings so as to translate the vehicle left or right to avoid obstructions, as shown in FIG. 12(h).

The vehicle described above is effective due to the employment of dynamic stability. Dynamic stability arises from (a) a surplus of forces generated by wings and body relative to the mass of the vehicle; (b) control systems to sense orientation and drive actuators to effect a desired change; (c) flexibility achieved by continuously altering the position of the wings and the body, switching partially or entirely amongst elevator, rudder, stabiliser, aileron and flap functions to effect any desired pose; and d) specific design considerations that increase effectiveness in these functions.

The “flight” control functions are provided entirely by independent control of the four wings (two forward wings and two rearward wings). For example: rudder function is achieved by each half of the rearward wing 17 being operated in the same sense (eg, both rotating clockwise to cause the vehicle to turn left); flap function is achieved by each half of the forward wings 16 operating in same sense; aileron function is achieved by each half of the main wing operating in the opposite sense (leading edge up on left & down on right causes vehicle to roll to left, and vice versa). The vehicle can be operated to perform almost any manoeuvre by independent control of the forward and rearward wings.

The vehicle has a number of innovative features leading to particular benefits for the specific application such as:
high hydrodynamic efficiency of wings and a low drag body and tether mean that negatively directed lift is sufficient to drive the vehicle to its desired depth whilst retaining positive buoyancy to prevent entanglement during deployment or retrieval;
high wing to be close to towing attachment point to minimise adverse roll induced when the vehicle moves laterally from the cable;
body profile area approximately similar to the main wing area so that it can exert a similar magnitude of lateral translational forces as the wing can exert ‘depth’ forces including an ability to resist upwards forces when the vehicle is rolled to 90 degrees (wings vertical, body horizontal);
relatively long moment arm of tail behind main wings, to reduce forces necessary for operation of rudder function and elevator function;
tail attached low on body, far from the towing cable attachment, so that rudder forces naturally tend to keep the body vertical when the tow cable is exerting a sideways force;
the choice of a V-tail, which means that turbulent vortex shedding from the body or forward wings during high-alpha (high angle of attack) manoeuvres can only ever mask a small fraction of the rudder/elevator surface area, and therefore ensures authoritative control during all phases of agile manoeuvring;
the choice of a more widely splayed v-tail than normally used in aviation, to favour elevator functions over rudder functions, in normal flight orientation;
choices of materials and distribution of weight to ensure that mass is heavily concentrated nearly to the vehicle's pivot point, meaning that the torque forces needed to effect changes in pitch, roll and yaw are minimised, which directly increases the responsiveness of the flight body, while at the same time, moment arms for exerting roll, pitch and yaw forces are maximised by the length of the wings and body;
high aspect ratio wings, with thin chords, distal taper and swept tips, to minimise drag and maximise lift, so that overall (tether plus underwater vehicle) drag is reduced and so that lift generated is capable of driving the vehicle to its operating depth without additional ballast.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

### REFERENCES

i. M. Underwood, M. Sherlock, A. Marouchos, K. Forcey and J. Cordell, “A Portable Shallow-Water Optic Fiber Towed Camera System for Coastal Benthic Assessment,” OCEANS 2018 MTS/IEEE Charleston, 2018, pp. 1-7, doi: 10.1109/OCEANS.2018.8604689.
ii. https://www.spotx.com.au/underwater-video-systems-and-rovs/drop-camera-live-underwater-gopro-video-to-tv-monitor-plotter-sounder
iii. http://www.sharkmarine.com/products/options-sidescan-sonar/depressor-wing/
iv. https://divexmarine.com/en/
v. https://www.sea-viewdiving.com/underwater-search-equipment/underwater-drop-video-cameras/jw-fisher-video/tov-2-hd-camera/
vi. https://ise.bc.ca/wp-content/uploads/2018/01/Aurora Towfish-New.pdf

1-23. (canceled)

24. A semi-autonomous towed underwater vehicle, comprising:
a body comprising one or more watertight chambers and external structural members;
forward wings attached to left and right sides of the body, with at least one wing oriented substantially horizontally;
one or more rearward wings attached to the body, with at least one independently operated actuator connected to an actuated portion oriented substantially at a horizontal angle, and at least one independently operated actuator connected to an actuated portion oriented substantially at a vertical angle;
one or more first sensors mounted on the body that collect biophysical or chemical data from the environment around the vehicle;
one or more second sensors mounted on the body that collect data about the movement of the vehicle through its environment;
an independent power source mounted in or on the body and capable of meeting the power supply needs of the actuators, the one or more first and second sensors, devices and processors of the semi-autonomous towed underwater vehicle, wherein the independent power source includes one or more of a storage cell, a storage cell requiring contact with seawater, and/or a means of converting water flow to electricity;
a processor mounted in the body that receives data from sensors and encodes the data for transmission, receives signals from a second processor mounted on the towing vessel, and generates control signals to independently actuate each moveable part of a wing to navigate the vehicle;
a second independently powered processor mounted in or on the towing vessel, that collects data related to surface conditions, processes data from the underwater vehicle, communicates data and instructions to the underwater vehicle, and communicates data to an operator;
a single tether cable that pulls the underwater vehicle through the water, and provides a means of communicating data between the underwater vehicle and the surface processor; and
a means of firmly connecting the single tether to the semi-autonomous towed underwater vehicle, and at an opposite end thereof to the towing vessel, in a manner that does not impede data transmission.

25. The semi-autonomous towed underwater vehicle of claim 24, wherein each of the forward wings has an aerofoil shape that provides negative lift when oriented at the correct angle of attack.

26. The semi-autonomous towed underwater vehicle of claim 25, wherein each of the one or more rearward wings has an aerofoil shape.

27. The semi-autonomous towed underwater vehicle of claim 24, wherein the one or more first sensors include one or more visible spectrum cameras, one or more wavelength-specific cameras, one or more depth measurement devices, and/or one of more acoustic sensors.

28. The semi-autonomous towed underwater vehicle of claim 24, wherein the one or more second sensors include pressure sensors and other sensors to measure movement of the semi-autonomous towed underwater vehicle, including sensors to measure pitch, yaw and roll, surge, sway, and heave.

29. The semi-autonomous towed underwater vehicle of claim 24, wherein:
the left side and right side forward wings contain moveable portions each connected to the same actuator and actuated in a manner that causes changes in airfoil shape to effect positive or negative pitching moments during underwater flight; or
the left and right side forward wings are connected to separate actuators.

30. The semi-autonomous towed underwater vehicle of claim 24, wherein the forward wings of the underwater vehicle include portions oriented at a substantially vertical angle, and these portions may include moveable portions connected to actuators.

31. The semi-autonomous towed underwater vehicle of claim 30, wherein the actuated portions include the entirety of a forward wing.

32. The semi-autonomous towed underwater vehicle of claim 24, further comprising third sensors on the towing vessel and/or the semi-autonomous towed underwater vehicle, to determine to location of the semi-autonomous towed underwater vehicle with respect to the towing vessel's location.

33. The semi-autonomous towed underwater vehicle of claim 24, wherein the body is substantially flattened in a vertical plane.

34. The semi-autonomous towed underwater vehicle of claim 24, wherein other underwater vehicles are towed from a common towing vessel.

35. The semi-autonomous towed underwater vehicle of claim 24, wherein the towing vessel is an aerial drone.
